(19) United States
(12) Patent Application Publication
(10) Pub. No.: US 2006/0201299 A1
(43) Pub. Date: Sep. 14, 2006

(54) Combination table-mitter saw & assembly

(76) Inventor: Roland C Santa Ana, Rockville, MD (US)

Correspondence Address: WHITE-WELKER & WELKER, LLC, P.O. BOX 199, CLEAR SPRING, MD, 21722-0199, US

(21) Appl. No.: 10/542,987

(22) PCT Filed: Jan. 21, 2003
(86) PCT No.: PCT/US03/01769

§ 371 Date: Jul. 21, 2005

(51) Int. Cl. B26D 7/02

(52) U.S. Cl. 83/468.3

(57) ABSTRACT

Combination table-miter saw and assembly for the industry of saws and tool table assemblies. Orientation of saw unit (18) may be adjusted for operation as table saw or miter saw. Includes a blade (20), handle (19), motor (21), slide bar (16), safety mechanism for table saw mode, arm support (3) attached to the worktable connecting the saw (18) to a side, knob handle tilt control (10) and scale (15). Work table is comprised of a table saw platform (1a), miter saw platform (1b) with radial shape, platform table insert (22), rail guide slot ramp (7), scale marking (8), and locking handle assembly (17). It includes an undercarriage secured to the worktable but allows its rotation, a fixed fence base (14) and foot bases (9) attached to the undercarriage. Fence (2), including a rail guide clamp handle (5), rail guide bar (6) and two clamp bolt knobs (4) are also included.

### TECHNICAL FIELD

This invention relates in general assemblies for saws, in particular to assemblies for table saws and miter saws. This invention is a novel combination table-miter saw and assembly with the ability to adjust the orientation of the saw unit in different angles, thus permitting the use of the tool as a table saw or as a miter saw at user's preference and in a short period of time.

### BACKGROUND ART

The prior art has diverse examples of saws and saw assemblies, all achieving distinct purposes. Nevertheless, none of the inventions present in the prior art disclose the improvement subject of this application, a combination table-miter saw and assembly with the novel characteristic of allowing the adjustment of the orientation of the saw for cutting a workpiece at different angles, therefore being able to adjust the tool into a table saw or into a miter saw.

U.S. Pat. No. 5,868,185 (Poling et al, 1999) describes a folding workbench system. The invention in the prior art is different to the combination table-miter saw and assembly because the first is a folding workbench system that does not resemble the assembly of the combination table-miter saw and assembly. The prior art invention does not have a work table with a radial shaped side such as the miter saw platform (1b) of the combination table-miter saw and assembly. In addition, this prior art invention does not include the safety mechanism or the adjustable foot bases of the combination table-miter saw and assembly.

U.S. Pat. No. No. 5,865,079 (Itzov, 1999) claims an adjustable workpiece support apparatus for a compound miter saw. This invention is different from the combination table-miter saw and assembly because it only refers to a miter saw, while the invention subject of this application refers to a tool and assembly that can be used as a table saw or as a miter saw at user's preference. Moreover, the prior art invention does not include two platforms such as the table saw platform (1a) and the radial shaped miter saw platform (1b), nor the safety mechanism or adjustable foot bases of the combination table-miter saw and assembly.

U.S. Pat. No. 5,842,400 (McIntosh, 1998) describes a table saw assembly with elements that are different from the elements of the combination table-miter saw and assembly. Although the invention in the prior art may do both straight and angled cuts, the combination table-miter saw and assembly has different elements such as the table saw platform (1a) and miter saw platform (1b), and is therefore aesthetically very different from the prior art invention. Moreover, the prior art invention does not have the safety mechanism nor the adjustable foot pads of the combination table-miter saw and assembly. In addition, the combination table-miter saw and assembly may be smaller and therefore occupy less space, thus giving greater advantage to user.

U.S. Pat. No. 5,437,319 (Garuglieri, 1995) is for a pivoting power tool with a table. The combination table-miter saw and assembly differs from the invention in the prior art because it has different elements, such as the table saw platform (1a) and miter saw platform (1b), and is therefore aesthetically very different from the prior art invention.

U.S. Pat. No. 5,331,875 (Mayfield, 1994) and U.S. Pat. No. 5,063,806 (Mayfield, 1991) are for an anti-kick forward device for radial arm saws. This combination table-miter saw and assembly invention differs from the inventions in the prior art because it has novel elements, such as the table saw platform (1a) and miter saw platform (1b), and is therefore aesthetically very different from the prior art inventions. In addition, the combination table-miter saw and assembly may be smaller and therefore easier to store and to transport from one place to another.

U.S. Pat. No. 5,353,670 (Metzger, Jr., 1994) is for independently and jointly operable radial saw guards; U.S. Pat. No. 5,287,780 (Metzger, Jr. et al, 1994) describes a radial arm saw guard with operational interlock; and U.S. Pat. No. 5,287,779 (Metzger, Jr., 1994) claims radial safety guards and barriers. These inventions differ from the combination table-miter saw and assembly because the latter is for a tool or saw to be used either as a table saw or a miter saw in a single assembly, and it has novel elements such as the table saw platform (1a) and miter saw platform (1b). In addition, the combination table-miter saw and assembly is aesthetically very different from the prior art inventions for the first has adjustable and removable non-slip foot bases (9) while the prior art inventions have long legs to support their tables.

U.S. Pat. No. 5,179,886 (Rathje, Jr., 1993) is for a radial beam arm saw table. This invention is different to the combination table-miter saw and assembly because the invention in the prior art has different elements than the combination table-miter saw and assembly. The combination table-miter saw and assembly has a characteristic table saw platform (1a) and miter saw platform (1b). In addition, the combination table-miter saw and assembly is aesthetically very different from the prior art invention for the first has non-slip foot bases (9) while the prior art invention has long legs to support its table. Furthermore, since the prior art invention has a table with long legs, it needs more stability, hence the use of the water tank, which gives stability or rigidity to the stand. This problem is not encountered by the combination table-miter saw and assembly, which has a smaller platform and foot bases, therefore having no stability nor rigidity issues, therefore being more practical for user. Moreover, the combination table-miter saw and assembly may be easily transported to any place chosen by user without the need to use water, which further differentiates it from the invention in the prior art.

U.S. Pat. No. 4,553,462 (Silken, 1985) claims a radial arm saw; U.S. Pat. No. 4,489,633 (van de Wouw, 1984) claims a sawing device and associated clamp and safety cap; U.S. Pat. No. 4,184,395 (Blachy et al, 1980) describes a radial arm saw; and U.S. Pat. No. 3,664,389 (Bower, 1972) makes reference to a lateral adjustment means for radial arm saws. The inventions in the prior art are aesthetically different to the combination table-miter saw and assembly because they do not have the novel table saw platform (1a) nor the miter saw platform (1b) as the workplace where the work piece will be cut.

U.S. Pat. No. 2,989,094 (Panavas, 1961) is for adjustable stops and guide bar for power tool; U.S. Pat. No. 2,628,643 (Tompkins, 1953) is for a wood sawing machine; and U.S. Pat. No. 2,590,093 (Fuerr, Jr., 1952) is for a hand-operated motor-driven radial machine tool. These inventions differ from the combination table-miter saw and assembly because their elements are different. In addition, the combination table-miter saw and assembly may be portable and therefore giving greater advantages to user.

### DISCLOSURE OF THE INVENTION

The present invention embodies a novel combination table-miter saw and assembly that allows the orientation of the saw to be adjusted at the worktable assembly and therefore may be used to perform multiple tasks with the same saw unit which may be used as a miter saw or as a table saw at user's preference. The elements of this invention are comprised of:

(a) A power tool or saw including a main saw unit (18), a saw blade (20), a handle grip with a motor switch control assembly (19), a motor (21), and a saw unit slide bar (16).

(b) A safety mechanism for the power tool or saw, comprising a locking knob assembly (11) for the slide bar (16) on the arm support (3), a stay-down blade lock knob (12), and a switch control for table saw (13).

(c) An arm support (3) attached to the rotatable work table and that connects the saw unit (18) to a side of the worktable, including a knob handle tilt control (10) and an angle tilt scale (15).

(d) The rotatable work table comprised of a table saw platform (1a) and a miter saw platform (1b) that has a radial shape, having the table saw platform (1a) a platform table insert (22), a rail guide slot ramp (7), a scale marking (8), and a locking handle assembly (17).

(e) An undercarriage secured to the worktable and that allows the platforms to rotate, also including a miter saw fixed fence base (14) and four adjustable non-slip foot bases (9) attached to each comer of the undercarriage.

(f) A stationary but removable fence (2), including a rail guide clamp handle (5), rail guide bar (6) and two clamp bolt knobs (4).

The combination table-miter saw and assembly can be operated as a table saw or as a miter saw. In case of a miter saw, the preferred embodiment may also be operated as a sliding miter saw. Some of the above elements will be relevant when used as a table saw, and others when used as a miter saw, as explained below.

For using the tool as a miter saw, user can put the work piece across the platform and against the fence (2) that has been placed on the miter saw fixed fence base (14). In addition, user may determine the cutting angle by rotating the worktable with the locking handle assembly (17).

The worktable may rotate but is secured to an undercarriage including a fixed fence base (14) and four adjustable and removable non-slip foot bases (9) attached to each comer of the undercarriage. In addition, the arm support (3) has a knob handle tilt control (10) that maybe tightened to adjust the saw blade (20) to a desired angle that shall be indicated on the angle tilt scale (15). These elements (10 and 15) may be used for performing compound angled cuts.

The saw unit slide bar (16) permits the saw unit (18) to slide, therefore being able to be used not only as a fixed miter saw, but also as a sliding miter saw, thus being able to cut from front to back of the work table and vice versa, and cutting as wide as 12 inches or greater. The desired angle for cutting is indicated by the scale at the miter saw platform (1b). With respect to the saw itself, user can operate it in miter saw mode by pressing the handle grip with motor switch control assembly (19) with his or her hand. Thereafter the motor (21) will be turned on, and the saw blade (20) will be ready for cutting. Therefore, for safety reasons, it is recommended that user place the work piece to be cut on the worktable or miter saw platform (1b), adjust the angle, and thereafter begin cutting it with the saw. The arm support (3) which connects the saw unit (18) to a side of the work table shall be shaped in a manner that allows the work piece to have clearance to pass through. This arm support (3) may be shaped as a “C.”

In addition, the fence (2) secures the work piece in place for cutting. The platform table insert (22) protects the saw blade (20) in case the saw unit (18) was carelessly handled by user and the saw blade (20) was misaligned.

To be operated under table saw mode, user must remove the fence (2) from its position, place the rail guide bar (6) inside the rail guide slot ramp (7) at the table saw platform (1a), and secure it by clamp or bolt knobs (4) to the side of the table saw platform (1a). The fence (2) may be used as a rail guide for the table saw conversion. The scale marking (8) in inches or centimeters serves as a guide to adjust the fence (2) to the desired width for cutting. The work piece must then be placed on the table saw platform (1 a) and the saw blade (20) will cut it on top of the platform table insert (22). The work piece may also be cut in an angle for the saw blade (20) may be adjusted to an angle by the knob handle tilt control (10) on the arm support (3).

To operate the saw under table saw mode, user must first tighten the slide bar's locking knob assembly (11) to secure the saw unit (18) into a set position to avoid accidents; thereafter lock the stay down blade lock knob (12) which secures the saw blade (20) into a downward position, and finally pushing the safety switch control (13) to lock the saw unit (18) into place. Unless these three elements of the safety mechanism (locking knob assembly (11), stay down lock knob (12), and safety switch control (13)) are locked or activated, user may not operate the tool as a table saw.

User may determine the angle of the cut in table saw mode by operating the knob handle tilt control (10) that can be tightened to adjust the saw blade (20) to the desired angle which will be indicated on the angle tilt scale (15). In addition, user may determine the length of the cut with the scale marking (8) at table saw platform (1a).

### OBJECTS AND ADVANTAGES OF THE INVENTION

The present invention constitutes a significant improvement in several aspects of previously identified efforts of the prior art as described below.

An object of the present invention is to provide a convenient work tool assembly that permits user to adjust the orientation of the tool in order to perform multiple tasks with the same work tool, being able to use this work tool as a miter saw or as a table saw. Therefore, user may perform several types of tasks with this novel invention, such as but not limited to cutting work pieces as a table saw e.g. cutting in a straight line or 90 degree angle, cross cutting, extended cross cutting, rip cutting, rip bevel cutting. When user accommodates the saw to be used as a miter saw, the tool will be able to do cuts such as but not limited to angle cutting, miter cutting, extended miter cutting, and compound angle cutting.

Another advantage of the present invention is that the combination table-miter saw and assembly will allow user to accommodate and cut work pieces of different thickness and diameter, being such work pieces such as but not limited to metal, wood, plywood, rubber or plastic.

Yet another object and advantage of this combination table-miter saw and assembly is to provide a tool that can easily be converted from a table saw to a miter saw or vice versa in a short period of time. The fact that one tool can have both uses of a table saw or a miter saw in one same equipment allows user to reduce space at his or her workplace for the invention provides less cumbersome tools for a tight workplace environment.

A further advantage of this combination table-miter saw and assembly is that since it can be used as a table saw or as a miter saw, user may have both uses in one single machine. Therefore, if user has to work in a construction site where he or she would have needed to transport both tools, he or she may save time in transporting this invention.

Yet another advantage of this combination table-miter saw and assembly is that it is very economical, for it provides two traditional tools in one, having a table saw and miter saw in one same assembly. Moreover, one embodiment of this invention may also permit the saw to slide, therefore also having a sliding miter saw with the same tool.

A further advantage of the present invention is that it is compatible to be used with various blades of different manufacturers, which makes it an invention flexible for the market.

Another advantage of the combination table-miter saw and assembly is that it has four adjustable and removable non-slip foot bases (9). The benefit conferred by these foot bases is that they may be adjustable in case the surface where the combination table-miter saw and assembly is placed were to be uneven and they prevent the invention from rocking, slipping or sliding on a surface.

Another object of the combination table-miter saw and assembly is to provide a tool whose arm support (3) permits a work piece to pass through without an obstruction in the middle, therefore permitting user to do ripping, bevel cuts or angled cuts with the saw.

Another object and advantage of the combination table-miter saw and assembly is that it provides effective safety features for user. The table saw may only be activated by first tightening the locking knob assembly (11) securing the saw unit slide bar (16) into place. Thus, the saw unit (18) will not be able to slide forward towards user. In addition, user must lock the stay down lock knob (12) which brings the saw blade (20) down into the platform table insert (22) and secures it in place. Finally, user must activate the safety switch control (13) in order to operate the table saw. Unless these three elements of the safety mechanism (locking knob assembly (11), stay down lock knob (12), and safety switch control (13)) are locked or activated, user may not operate the tool as a table saw. Therefore, user is protected from the saw unit (18) sliding towards him or her and from the saw blade (20) getting out of place by the security features mentioned herein above. Thus, this combination table-miter saw and assembly has efficient means of protecting user from accidents.

A further advantage of this invention is that it includes a stationary but removable fence (2) that may be used as a support for the miter saw and as a rail guide for the table saw conversion, therefore reducing the amount of parts needed to operate the invention in both saw modes.

Finally, another advantage of the combination table-miter saw is that a work piece may enter or start in the front or in the back of the table saw platform (1a), at user's preference and depending on the use of the saw blade (20). This is an advantage because by being able to start the work piece behind the saw unit (18), user prevents kickback and jamming (the latter being able to ruin the motor) from any big teeth blade, and therefore prevents accidents.

### BRIEF DESCRIPTION OF DRAWINGS

The present application includes several drawings that illustrate an embodiment of the invention. However, the scope of the combination table-miter saw & assembly is limited only by the scope of the claims, and not by a particular embodiment shown in the drawings.

FIG. 1 is a side view of an embodiment of the combination table-miter saw and assembly adjusted to its miter saw mode, being this a sliding miter saw. The figure illustrates the rotatable worktable assembly comprised of the table saw platform (1a), the platform table insert (22), the locking handle assembly (17), the miter saw platform (1b), the adjustable non-slip foot base (9), the miter saw fixed fence base (14), the stationary but removable fence (2), the clamp bolt knob (4) that secures the fence (2) to the miter saw fixed fence base (14), the rail guide lot ramp (7) which is used to guide the fence (2), the saw unit (18), the saw blade (20), the handle grip with motor switch control assembly (19) for initializing the tool into its miter saw mode, the motor (21), the saw unit slide bar (16) for sliding the miter saw, and the arm support (3) that enables the saw unit (18) to be moved in angles for cutting the work pieces.

FIG. 2. is a side elevation view of the worktable and of the fence (2), both to be used for the table saw mode. It includes the table saw platform (1a), rail guide slot ramp (7), platform table insert (22) where the saw blade shall cut the work piece, a locking handle assembly (17), a scale marking (8), and the miter saw platform (1b). The locking handle assembly (17) is only for the miter saw mode, and it is a handle to move or rotate the worktable to a desired angle. In addition, this figure illustrates the fence (2), including the rail guide clamp handle (5), the rail guide bar (6) which is meant to be inserted into the rail guide slot ramp (7), and clamp bolt knobs (4).

FIG. 3. is a side view of the worktable to be used for the table saw, including the table saw platform (1a), the rail guide clamp handle (5), clamp bolt knob (4), arm support (3), miter saw platform (1b), miter saw fixed fence base (14), adjustable non-slip foot base (9), platform table insert (22), and locking handle assembly (17).

FIG. 4 is a side view of the combination table-miter saw and assembly ready to be used as a table saw. It includes the main saw unit (18), the saw unit slide bar (16) for sliding the saw unit (18) using the miter saw mode but not to be used in the table saw mode, the motor (21), the slide bar locking knob assembly (11) which must be tightened for operation of the table saw, the safety switch control (13), the handle grip with motor switch control assembly (19), the stay down lock knob (12) for securing the saw blade (20) in place, the saw blade (20), the locking handle assembly (17) which is used for the miter saw, the fence (2), the clamp bolt knob (4) which secures the fence (2), the miter saw fixed fence base (14), the table saw platform (1a), the arm support (3), the knob handle tilt control (10) and the angle tile scale (15) for bevel cutting.

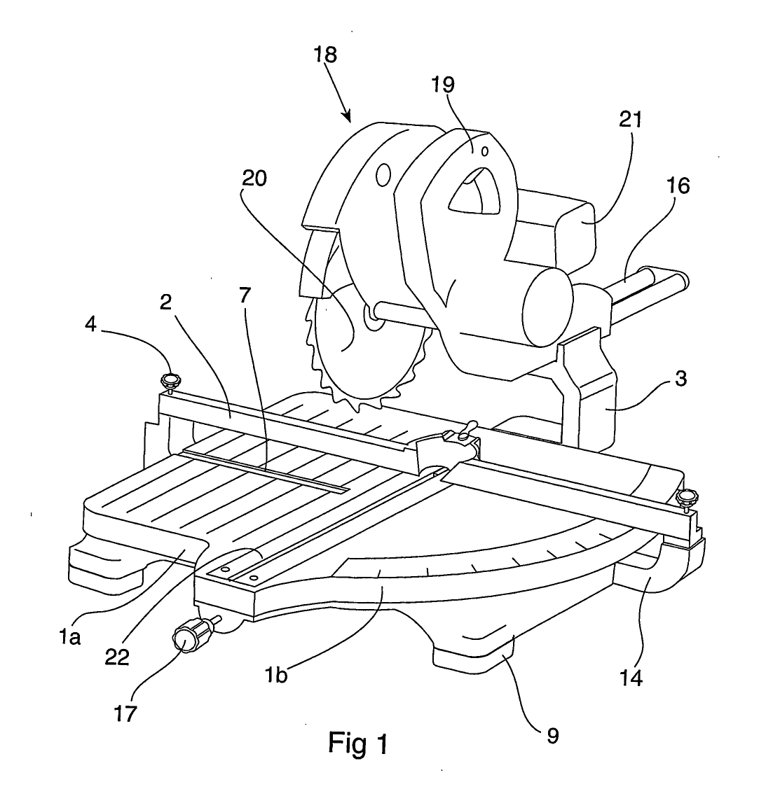

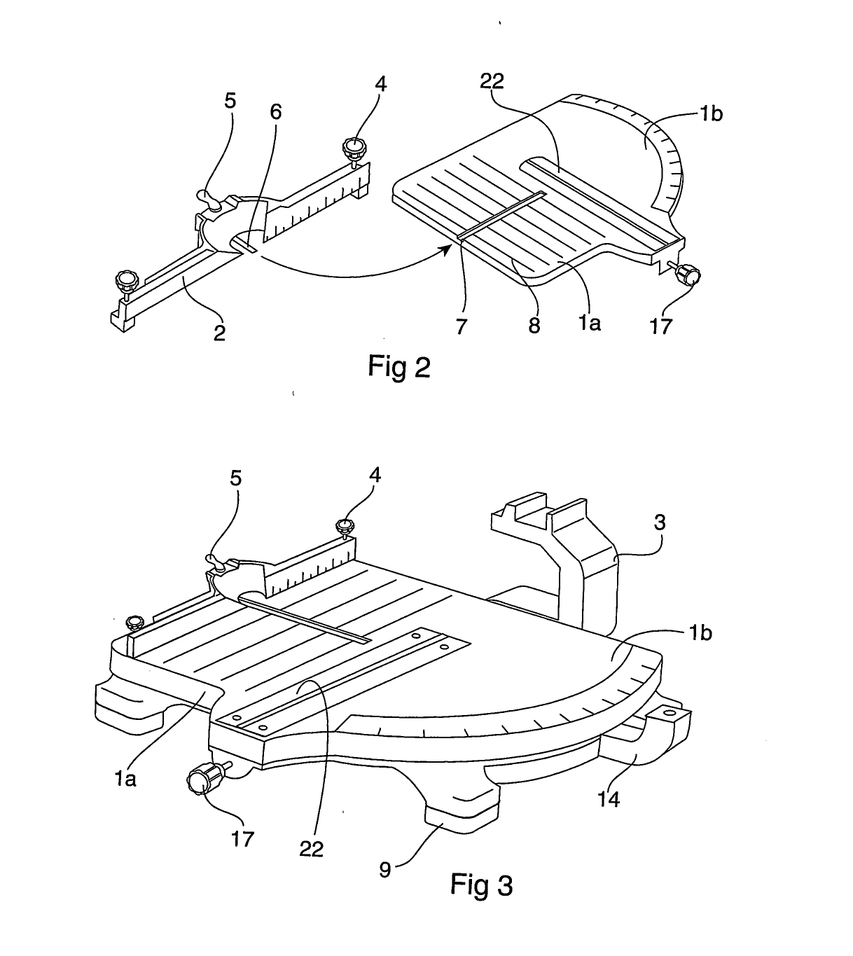

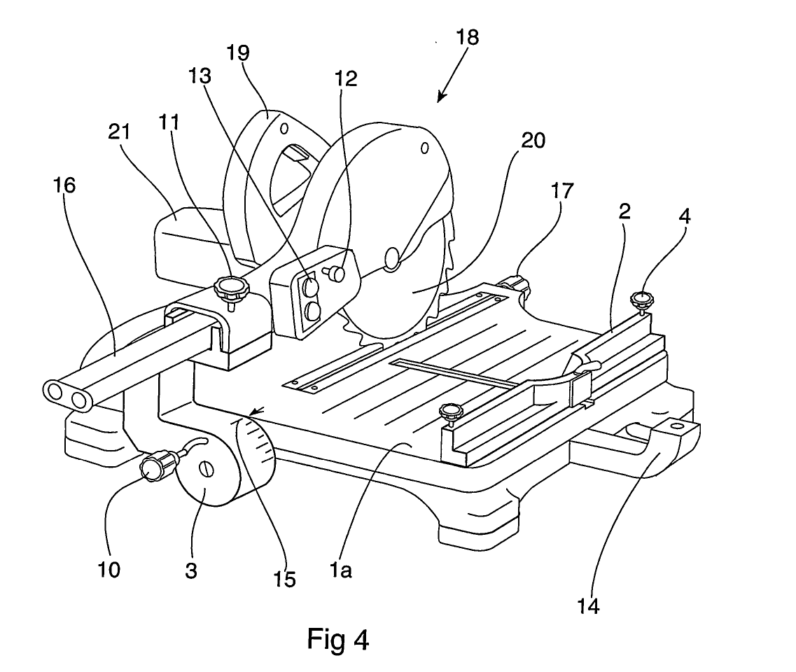

### DESCRIPTION OF PREFERRED EMBODIMENT/BEST MODE

Having described the invention and its modes of operation in the paragraphs hereinabove, following is the description of the preferred embodiment. The elements of the preferred embodiment of this combination table-miter saw & assembly invention are comprised of:

(a) A power tool or saw including a main saw unit (18), a saw blade (20), a handle grip with a motor switch control assembly (19), a motor (21), and a saw unit slide bar (16).

(b) A safety mechanism for the power tool or saw, comprising a locking knob assembly (11) for securing the slide bar (1 6) on the arm support (3) and therefore secure the saw unit (18) in place, a stay-down blade lock knob (12) to secure the blade (20) to a downward position, and a switch control for table saw (13).

(c) An arm support (3) shaped as a “C,” attached to the rotatable worktable and that connects the saw unit (18) to a side of the worktable, including a knob handle tilt control (10) that when loosened may determine the angle of the saw blade (20) and an angle tilt scale (15) that will indicate the chosen angle.

(d) The rotatable work table comprised of a table saw platform (1a) and a miter saw platform (1b) that has a radial shape, having the table saw platform (1a) a platform table insert (22) where the saw blade (20) will perform its cutting, a rail guide slot ramp (7) for placing the fence (2) when the invention is used as a table saw, a scale marking (8) in inches or centimeters to guide the fence (2), and a locking handle assembly (17) to turn the platform to a desired angle.

(e) An undercarriage secured to the worktable and that allows the platforms to rotate, including a miter saw fixed fence base (14) for placing the fence (2) for operation of the invention under miter saw mode, and four adjustable and removable non-slip foot bases (9) attached to each comer of the undercarriage.

(f) A stationary but removable fence (2), including a rail guide clamp handle (5) to be inserted with the rail guide bar (6) into the rail guide slot ramp (7) for securing the fence (2) to the worktable for table saw operation, and two clamp bolt knobs (4) that secure the fence (2) to the worktable.

The preferred embodiment of the invention shall be made of metal, except for the non slip foot base (9) that shall be made of rubber and the platform table insert (22) that shall be made of plastic.

With respect to the best mode and operation of the invention, the combination table-miter saw and assembly may be operated as a table saw or as a sliding or fixed miter saw.

For using the tool as a miter saw, user can put the work piece across the platform and against the fence (2) that has been placed on the miter saw fixed fence base (14). In addition, user may determine the cutting angle by rotating the worktable with the locking handle assembly (17).

The worktable may rotate but is secured to an undercarriage including a fixed fence base (14) and four adjustable and removable non-slip foot bases (9) attached to each corner of the undercarriage. In addition, the arm support (3) has a knob handle tilt control (10) that may be tightened to adjust the saw blade (20) to a desired angle that shall be indicated on the angle tilt scale (15). These elements (10 and 15) maybe used for performing compound angled cuts.

The saw unit slide bar (16) permits the saw unit (18) to slide, therefore being able to be used not only as a fixed miter saw, but also as a sliding miter saw, thus being able to cut from front to back of the work table and vice versa, and cutting as wide as 12 inches or greater. The desired angle for cutting is indicated by the scale at the miter saw platform (1b). With respect to the saw itself, user can operate it in miter saw mode by pressing the handle grip with motor switch control assembly (19) with his or her hand. Thereafter the motor (21) will be turned on, and the saw blade (20) will be ready for cutting. Therefore, for safety reasons, it is recommended that user place the work piece to be cut on the worktable or miter saw platform (1b), adjust the angle, and thereafter begin cutting it with the saw. The arm support (3) which connects the saw unit (18) to a side of the worktable shall be shaped in a manner that allows the work piece to have clearance to pass through. In the preferred embodiment, this arm support shall be shaped as a “C.”

In addition, the fence (2) secures the work piece in place for cutting. The platform table insert (22) protects the saw blade (20) in case the saw unit (1 8) was carelessly handled by user and the saw blade (20) was misaligned.

To be operated under table saw mode, user must remove the fence (2) from its position, place the rail guide bar (6) inside the rail guide slot ramp (7) at the table saw platform (1a), and secure it by clamp or bolt knobs (4) to the side of the table saw platform (1a). The fence (2) maybe used as a rail guide for the table saw conversion. The scale marking (8) in inches or centimeters serves as a guide to adjust the fence (2) to the desired width for cutting. The work piece must then be placed on the table saw platform (1a) and the saw blade (20) will cut it on top of the platform table insert (22). The work piece may also be cut in an angle because the saw blade (20) may be adjusted to an angle by the knob handle tilt control (10) on the arm support (3).

To operate the saw in table saw mode, user must first tighten the slide bar locking knob assembly (11) to secure the saw unit (18) into a set position to avoid accidents; thereafter lock the stay down blade lock knob (12) which secures the saw blade (20) into a downward position, and finally pushing the safety switch control (13) to lock the saw unit (18) into place. Unless these three elements (locking knob assembly (11), stay down lock knob (12), and safety switch control (13)) of the safety mechanism are locked or activated, user may not operate the tool as a table saw.

User can determine the angle of the cut in table saw mode by operating the knob handle tilt control (10) that can be tightened to adjust the saw blade (20) to the desired angle which will be indicated on the angle tilt scale (15). In addition, user may determine the length of the cut with the scale marking (8) at the table saw platform (1a).

### Description of Alternate Embodiments

The present invention embodies a combination table-miter saw & assembly. As mentioned above, the preferred embodiment of the invention is made of metals. Alternative embodiments of the invention are made of materials such as but not limited to plastic, rubber or man made materials. With respect to the locking handle assembly (17), the preferred embodiment is made of metal, and alternate embodiments may be made of rubber, plastic or man made materials. In connection to the adjustable and removable non slip foot base (9), the preferred embodiment is made of rubber, while other embodiments may have such element made of materials such as but not limited to plastic or man made materials. The saw blade (20) may be made of metal or of carbide.

In an embodiment of the invention the work tool may be used as a table saw or as a fixed miter saw. In this embodiment, the saw unit slide bar (16) is suppressed from the invention.

In another embodiment of the invention, user may remove the saw unit (18), the handle with grip with motor switch control assembly (19), the saw blade (20), and the motor (21), and replace them with any other compatible elements that may be sold in the market and that serve the same purposes. Therefore, this embodiment may be flexible to adjust to other saw units in the market.

The invention is not however limited to materials and embodiments described above; they are given as examples only. The scope of the invention should be determined by its claims, and not by a particular embodiment of the invention.

I claim:

1. A combination table-miter saw and assembly characterized and comprised of:
(a) A power tool or saw including a main saw unit (18), a saw blade (20), a handle grip with a motor switch control assembly (19), a motor (21), and a saw unit slide bar (16), thus enabling the tool to be operated as a table saw, fixed miter saw or sliding miter saw.
(b) A safety mechanism for the power tool or saw, comprising a locking knob assembly (11) for the slide bar (16) on the arm support (3), a stay-down blade lock knob (12), and a switch control for table saw (13), and wherein unless these three elements of the safety mechanism (locking knob assembly (11), stay down lock knob (12), and safety switch control (13)) are locked or activated, user may not operate the tool as a table saw.
(c) An arm support (3) of a shape that permits a work piece to pass through without being obstructed, attached to the rotatable worktable and that connects the saw unit (18) to a side of the worktable, including a knob handle tilt control (10) and an angle tilt scale (15).
(d) The rotatable work table comprised of a table saw platform (1a) and a miter saw platform (1b), having these platforms the same or different shapes, having the table saw platform (1a) a platform table insert (22), a rail guide slot ramp (7), a scale marking (8), and a locking handle assembly (17).
(e) An undercarriage that will be secured to the worktable but that will enable the platforms to rotate and that includes a miter saw fixed fence base (14) and four adjustable and removable non-slip foot bases (9) attached to each comer of the undercarriage.
(f) A stationary but removable fence (2), including a rail guide clamp handle (5), rail guide bar (6) and two clamp bolt knobs (4).

2. A combination table-miter saw and assembly characterized and comprised of:
(a) A power tool or saw including a main saw unit (18), a saw blade (20), a handle grip with a motor switch control assembly (19) for using the miter saw, a motor (21), and a saw unit slide bar (16), thus enabling the tool to be operated as a table saw, fixed miter saw or sliding miter saw.
(b) A safety mechanism for the power tool or saw, comprising a locking knob assembly (11) for securing the slide bar (16) on the arm support (3) and therefore secure the saw unit (18) in place, a stay-down blade lock knob (12) to secure the saw blade (20) to a downward position, and a switch control for table saw (13), and wherein unless these three elements of the safety mechanism (locking knob assembly (11), stay down lock knob (12), and safety switch control (13)) are locked or activated, user may not operate the tool as a table saw.
(c) An arm support (3) of a shape that permits a work piece to pass through without being obstructed, attached to the rotatable worktable and that connects the saw unit (18) to a side of the worktable, including a knob handle tilt control (10) that when loosened may determine the angle of the saw blade (20) and an angle tilt scale (15) that will indicate the chosen angle.
(d) The rotatable work table comprised of a table saw platform (1a) and a miter saw platform (1b) that may be of the same or of different shapes, having the table saw platform (1a) a platform table insert (22) where the saw blade (20) will perform cutting, a rail guide slot ramp (7) for placing the fence (2) when the invention is used as a table saw, a scale marking (8) to guide the fence (2), and a locking handle assembly (17) to turn the platform to a desired angle.
(e) An undercarriage that will be secured to the worktable but that will enable the platforms to rotate and that includes a miter saw fixed fence base (14) for placing the fence (2) for operation of the invention under miter saw mode, and four adjustable and removable non-slip foot bases (9) attached to each corner of the undercarriage.
(f) A stationary but removable fence (2) for use with the miter saw and as a rail guide table saw conversion, including a rail guide clamp handle (5) to be inserted with the rail guide bar (6) into the rail guide slot ramp (7) for securing the fence (2) to the worktable for table saw operation, and two clamp bolt knobs (4) that secure the fence (2) to the worktable.

3. The tool described in claim 1 wherein the arm support (3) is of shapes such as but not limited to “C” or “L”, wherein the miter saw platform (1b) is of a radial shape, and wherein the scale marking (8) illustrates inches or centimeters.

4. The tool described in claim 2 wherein the arm support (3) is of shapes such as but not limited to “C” or “L”, wherein the miter saw platform (1b) is of a radial shape, and wherein the scale marking (8) illustrates inches or centimeters.

5. The tool described in claim 1 wherein its elements are made of materials such as but not limited to metals, carbide, plastic, rubber or man made materials.

6. The tool described in claim 2 wherein its elements are made of materials such as but not limited to metals, carbide, plastic, rubber or man made materials.

7. The tool described in claim 3 wherein its elements are made of materials such as but not limited to metals, carbide, plastic, rubber or man made materials.

8. The tool described in claim 4 wherein its elements are made of materials such as but not limited to metals, carbide, plastic, rubber or man made materials.

9. The tool described in claim 1 wherein any of the main saw unit (18), saw blade (20), handle grip with a motor switch control assembly (19), motor (21), and/or saw unit slide bar (16) may be removable, making the other elements of the tool compatible to be used with other saws or elements in the prior art and in the market, and wherein the sole removal of the saw unit slide bar (16) allows the tool or saw to be used as a table saw or fixed miter saw.

10. The tool described in claim 2 wherein any of the main saw unit (18), saw blade (20), handle grip with a motor switch control assembly (19), motor (21), and/or saw unit slide bar (16) may be removable, making the other elements of the tool compatible to be used with other saws or elements in the prior art and in the market, and wherein the sole removal of the saw unit slide bar (16) allows the tool or saw to be used as a table saw or fixed miter saw.

11. The tool described in claim 5 wherein any of the main saw unit (18), saw blade (20), handle grip with a motor switch control assembly (19), motor (21), and/or saw unit slide bar (16) may be removable, making the other elements of the tool compatible to be used with other saws or elements in the prior art and in the market, and wherein the sole removal of the saw unit slide bar (16) allows the tool or saw to be used as a table saw or fixed miter saw.

12. The tool described in claim 6 wherein any of the main saw unit (18), saw blade (20), handle grip with a motor switch control assembly (19), motor (21), and/or saw unit slide bar (16) may be removable, making the other elements of the tool compatible to be used with other saws or elements in the prior art and in the market, and wherein the sole removal of the saw unit slide bar (16) allows the tool or saw to be used as a table saw or fixed miter saw.

13. The tool described in claim 1 wherein the elements are small, of lightweight materials, and thus is portable.

14. The tool described in claim 2 wherein the elements are small, of lightweight materials, and thus is portable.

15. The tool described in claim 9 wherein the elements are small, of lightweight materials, and thus is portable.

16. The tool described in claim 10 wherein the elements are small, of lightweight materials, and thus is portable.
